(19) United States
(12) Patent Application Publication
(10) Pub. No.: US 2026/0080482 A1
(43) Pub. Date: Mar. 19, 2026

(54) APPARATUSES, SYSTEMS, AND METHODS OF PROTECTING A DOWN-PAYMENT VALUE ASSOCIATED WITH A PURCHASE OF A DEPRECIATING ASSET

(71) Applicant: William Kizzie, Mt. Juliet, TN (US)

(72) Inventor: William Kizzie, Mt. Juliet, TN (US)

(21) Appl. No.: 19/327,220

(22) Filed: Sep. 12, 2025

Related U.S. Application Data
(60) Provisional application No. 63/694,945, filed on Sep. 16, 2024.

(51) Int. Cl. G06Q 40/08

(52) U.S. Cl. CPC G06Q 40/086; G06Q 40/08223

(57) ABSTRACT

A method for protecting a down-payment value associated with a purchase of a depreciating asset is disclosed herein. The depreciating asset may be identified, the purchase of the depreciating asset may be initiated, one or more characteristics associated with the purchase of the depreciating asset may be identified, and the down-payment value associated with a purchase of the depreciating asset may be acquired. At least one of one or more adjustment models corresponding to the purchase of the depreciating asset may be selected. And, a percentage of the down-payment value associated with the purchase of the depreciating asset may be calculated based at least in part on the at least one of the one or more adjustment models. A payment amount may be generated based upon at least the calculated percentage of the down-payment value associated with the purchase of the depreciating asset.

This is a U.S. non-provisional patent application filed by William Kizzie, a citizen of the United States residing in Mount Juliet, Tennessee, for the invention titled “APPARATUSES, SYSTEMS, AND METHODS OF PROTECTING A DOWN-PAYMENT VALUE ASSOCIATED WITH A PURCHASE OF A DEPRECIATING ASSET.”

A portion of the disclosure of this patent document contains material that is subject to copyright protection. The copyright owner has no objection to the reproduction of the patent document or the patent disclosure, as it appears in the U.S. Patent and Trademark Office (USPTO) patent file or records, but otherwise reserves all copyright rights whatsoever.

### CROSS-REFERENCES TO RELATED APPLICATIONS

The present application claims priority to, and benefit from, U.S. provisional patent application number 63/694,945, filed on Sep. 16, 2024, and which is incorporated by reference in its entirety.

### FIELD OF THE DISCLOSURE

The present disclosure relates to a product or a solution for a financial, automotive or vehicular, and/or insurance industry, and more particularly to apparatuses, systems, and methods for protecting a down-payment value associated with a purchase of a depreciating asset.

### BACKGROUND

Current provisions of insurance, insurance coverage, or insurance protection (each, an “insurance product”) enable a user—a driver or operator—to cover a value of a depreciating asset purchased and/or financed by the user. Examples of the depreciating asset include (without limitation) a motorized vehicle (e.g., automobiles, motorcycles, tractor-trailer trucks, or buses), a railed vehicle (e.g., trains, trams, or trolleys), a watercraft (e.g., ships or boats), an amphibious vehicle (e.g., screw-propelled vehicles or hovercraft), or an aircraft (e.g., airplanes, helicopters, or aerostat). When seeking to purchase a new or previously used depreciating asset, the user will customarily provide a down payment towards a percentage of a purchase price, financing a remaining balance of the purchase price for a specified term, such as, for example, four (4) to six (6) years. During the specified term, otherwise referred to as a “financing period,” the depreciating asset undergoes substantial depreciation. For example, automobiles typically depreciate at non-linear, or volatile, rates, with depreciation between twenty percent (20%) and thirty percent (30%) in a first year after the purchase of the automobile, and depreciation around sixty percent (60%) or more for a period of up to five years after the purchase of the automobile. Rapid deprecation of the depreciating asset (e.g., the automobile), however, exposes the user to a potential loss of the user's down payment made towards the percentage of the purchase price. An illustrative example of the user's potential loss of the user's down payment is provided below.

A consumer—an anticipated user—initiates a purchase of an automobile, the automobile serving as an exemplary embodiment of the depreciating asset. The automobile is valued at a purchase price of $40,000.00. The consumer provides a down payment towards a percentage of the purchase price to an owner of the automobile, the owner of which may be a then-current user of the automobile or a third-party organization, such as a dealership. An amount of the down payment is $5,000.00. The consumer then elects to finance the remaining $35,000.00. Optionally, but customarily, the consumer may add “gap” insurance to protect the consumer's financial interests in an event of liability, collision, or other claim against the consumer related to an operation of the automobile. Many months later, the consumer is in an accident or collision involving the automobile. An insurance adjuster, or other pertinent third-party individual or entity, declares that the automobile is “totaled”—i.e., a value of estimated repairs for the automobile exceeds a fair-market value (FMV) of the automobile. Specifically, the insurance adjuster calculates the FMV of the automobile to constitute $28,000.00, which is $12,000.00 lower than the original purchase price—a thirty percent (30%) decrease. After paying a deductible under the consumer's applicable insurance product, such as an amount of $500.00, the insurance company agrees to tender payment to the consumer in the amount of $27,500.00 for the vehicle. To this date, however, a balance of $34,000.00 remains as a value owed by the consumer for the financing of the automobile. Assuming the consumer purchased “gap” insurance, a provider of the “gap”insurance covers a difference between $27,500.00 and $34,000.00: $6,500.00.

In the illustrative example above, aside from payments of premiums and/or deductibles for the insurance product, the consumer's liability for the automobile accident is eliminated. In other words, the consumer owes $0.00 to cover any remaining financial liabilities for the automobile accident. While the financial liability for the automobile accident has been eliminated, the consumer has nevertheless suffered a loss measured as a value of the down payment made towards a percentage of the purchase price of the automobile. Stated differently, the consumer, as in this example, is unable to recover or regain the value of the down payment—$5,000.00. The loss of the value of the down payment prevents, deters, or otherwise cripples the consumer from tendering another down payment of a similar quantity toward a purchase price of another of the automobile. Consequently, the consumer is financially disadvantaged as a result of the loss of the value of the down payment. Thus, there is a need to provide apparatuses, methods, or systems that overcome the foregoing limitations.

### BRIEF SUMMARY

Embodiments of apparatuses, methods, and systems of the present disclosure provide a solution to the shortcomings above. In particular, this disclosure provides a down-payment value protection solution that protects a consumer from incurring a loss, or non-recovery, of a value of a down payment made towards a purchase price of a depreciating asset. This unique, one-of-a-kind down-payment value protection solution is the world's first down-payment value protection solution that protects a consumer's financial interests with respect to the consumer's down payment(s) made towards the purchase price of a depreciating asset. Now, for the consumer that elects to finance a purchase of the depreciating asset, the down-payment value protection solution ensures that the consumer's personal, financial investment will be fully protected in the event of liability, a collision, or other claim against the consumer related to an operation of the depreciating asset.

In the context of protecting a down-payment value associated with a purchase of a depreciating asset, certain embodiments of a method for protecting the down-payment value associated with the purchase of the depreciating asset are disclosed. A depreciating asset may be identified, the purchase of the depreciating asset may be initiated, one or more characteristics associated with the purchase of the depreciating asset may be identified, and the down-payment value associated with a purchase of the depreciating asset may be acquired. At least one of one or more adjustment models corresponding to the purchase of the depreciating asset may be selected. And, a percentage of the down-payment value associated with the purchase of the depreciating asset may be calculated based at least in part on the at least one of the one or more adjustment models. A payment amount may be generated based upon at least the calculated percentage of the down-payment value associated with the purchase of the depreciating asset based at least in part on the at least one of the one or more adjustment models.

In the context of protecting a down-payment value associated with a purchase of a depreciating asset, certain embodiments of a system for protecting the down-payment value associated with the purchase of the depreciating asset are disclosed. The system may include a network, an electronic device, and a computing device. The electronic device may have a communication section communicatively couplable to the network, and the electronic device may be configured to transmit an identification of a depreciating asset. The computing device may have a communication section communicatively couplable to the network. The computing device may be configured to receive a down-payment value associated with a purchase of the depreciating asset. The computing device may be additionally configured to select, from a storage medium, at least one of one or more adjustment models corresponding to the purchase of the depreciating asset. The computing device may also be configured to calculate a percentage of the down-payment value associated with the purchase of the depreciating asset based at least in part on the at least one of the one or more adjustment models.

In one particular and exemplary embodiment, a method of protecting a down-payment value associated with the purchase of a depreciating asset is provided. The method may commence with an operation of identifying a depreciating asset. The method may continue with an operation of initiating the purchase of the depreciating asset. The method may continue with an operation of identifying one or more characteristics associated with the purchase of the depreciating asset. The method may continue with an operation of acquiring the down-payment value associated with a purchase of the depreciating asset.

In one exemplary aspect according to the above-referenced embodiment, the method may further continue with an operation of obtaining one or more valuations associated with the depreciating asset and applying one of the one or more valuations to the depreciating asset.

In another exemplary aspect according to the above-referenced embodiment, the one or more valuations may include one or more of a comparable valuation, a value-extrapolation valuation, or other industry-standard valuation approaches.

In another exemplary aspect according to the above-referenced embodiment, the method may further continue with an operation of selecting at least one of one or more adjustment models corresponding to the purchase of the depreciating asset. The at least one of the one or more adjustment models may account for one or more of adjustment factors as follows: an age of an anticipated user of the depreciating asset; a sex of the anticipated user of the depreciating asset; a primary location of the anticipated user of the depreciating asset; an accident history of the anticipated user; a type of the depreciating asset; a make and a model of the depreciating asset; an age of the depreciating asset; a service life of the depreciating asset; a service history of the depreciating asset; an actual or expected extent of usage of the depreciating asset; an expected frequency of usage of the depreciating asset; or a type of usage of the depreciating asset.

In another exemplary aspect according to the above-referenced embodiment, the method may further continue with an operation of weighting one or more of the adjustment factors.

In another exemplary aspect according to the above-referenced embodiment, the type of depreciating asset may include one or more of a motorized vehicle, a railed vehicle, a watercraft, an amphibious vehicle, an aircraft, or a spacecraft.

In another exemplary aspect according to the above-referenced embodiment, the at least one of the one or more adjustment models may account for adjustment factors as follows: a valuation of the depreciating asset, and the down-payment value associated with the purchase of the depreciating asset.

In another exemplary aspect according to the above-referenced embodiment, the method may further continue with an operation of calculating a percentage of the down-payment value associated with the purchase of the depreciating asset based at least in part on the identified one or more characteristics associated with the purchase of the depreciating asset; and generating a payment amount based upon at least the calculated percentage of the down-payment value associated with the purchase of the depreciating asset based at least in part on the at least one of the one or more adjustment models.

In another exemplary aspect according to the above-referenced embodiment, the method may further continue with an operation of acquiring a contractual liability insurance policy (CLIP) from an insurer.

In another exemplary aspect according to the above-referenced embodiment, the method may further continue with an operation of receiving a request for reimbursement of the down-payment value after a triggering event occurs.

In another exemplary aspect according to the above-referenced embodiment, the method may further continue with an operation of investigating the request for reimbursement of the down-payment value.

In another exemplary aspect according to the above-referenced embodiment, the method may further continue with an operation of receiving notification that the reimbursement of the down-payment value is authorized.

In another embodiment, a system for protecting a down-payment value associated with a purchase of a depreciating asset is provided. The system includes a network, an electronic device, and a computing device. The electronic device has a communication section that is communicatively couplable to the network, and the electronic device is configured to transmit an identification of a depreciating asset. The computing device has a communication section communicatively couplable to the network. The computing device is configured to receive the down-payment value associated with a purchase of the depreciating asset. The computing device is also configured to select, from a storage medium, at least one of one or more adjustment models corresponding to the purchase of the depreciating asset. The computing device is further configured to calculate a percentage of the down-payment value associated with the purchase of the depreciating asset based at least in part on the at least one of the one or more adjustment models. The electronic device, the computing device, and/or network is configured to direct performance of remaining operations from the above-referenced method embodiment and optionally any of the described exemplary aspects thereof.

In one particular and exemplary embodiment, a method of distributing a down-payment value associated with the purchase of a depreciating asset is provided. The method may commence with an operation of receiving a request for reimbursement of the down-payment value after a triggering event occurs. The method may continue with an operation of investigating the request for reimbursement of the down-payment value. The method may continue with an operation of receiving notification that the reimbursement of the down-payment value is authorized. The method may continue with an operation of distributing the down-payment value.

Unless otherwise defined, all technical and scientific terms used herein have the same meaning as commonly understood by one of ordinary skill in the art to which this invention belongs. The present invention may be embodied in other specific forms without departing from the spirit or essential attributes thereof, and it is therefore desired that the present embodiment be considered in all aspects as illustrative and not restrictive. Any headings utilized in the description are for convenience only and no legal or limiting effect. Numerous objects, features, and advantages of the embodiments set forth herein will be readily apparent to those skilled in the art upon reading of the following disclosure when taken in conjunction with the accompanying drawings.

### BRIEF DESCRIPTION OF THE DRAWINGS

Hereinafter, various exemplary embodiments of the disclosure are illustrated in more detail with reference to the drawings.

FIG. 1 illustrates an exemplary embodiment of a partial block diagram of an electronic device, in accordance with aspects of the present disclosure.

FIG. 2 illustrates an exemplary embodiment of a partial block diagram of a computing device, in accordance with aspects of the present disclosure.

FIG. 3 illustrates an exemplary embodiment of a partial block diagram of a server, in accordance with aspects of the present disclosure.

FIG. 4 illustrates an exemplary embodiment of a partial network diagram of a system of protecting a down-payment value associated with a purchase of a depreciating asset, in accordance with aspects of the present disclosure.

FIG. 5 illustrates a flowchart providing an exemplary embodiment of a method of protecting a down-payment value associated with a purchase of a depreciating asset, in accordance with aspects of the present disclosure.

FIG. 6 illustrates a flowchart providing another exemplary embodiment of a method of protecting a down-payment value associated with a purchase of a depreciating asset, in accordance with aspects of the present disclosure.

FIG. 7 illustrates a flowchart providing an exemplary embodiment of a method of distributing a down-payment value associated with a purchase of a depreciating asset after a triggering event has occurred, in accordance with aspects of the present disclosure.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

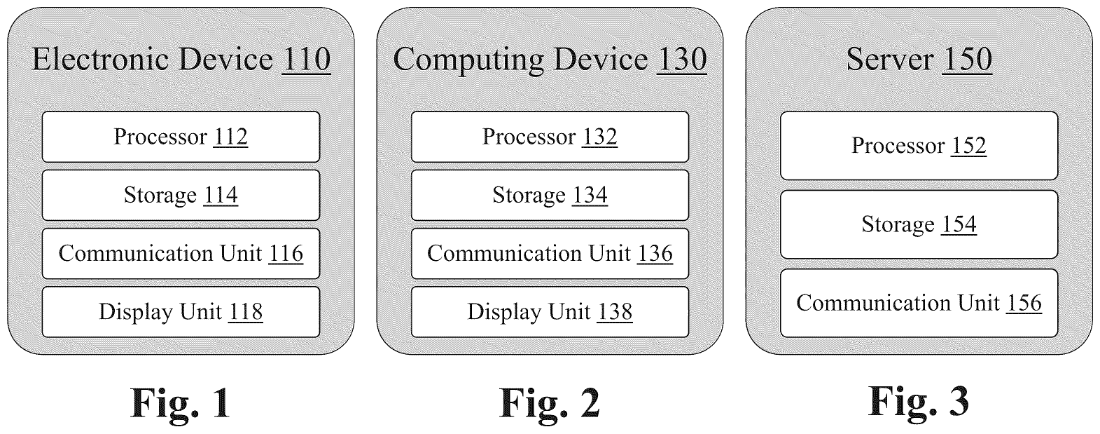

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure. Referring generally to FIGS. 1-7, various exemplary embodiments may now be described of apparatuses, systems, and methods for protecting a down-payment value associated with a purchase of a depreciating asset. Where the various figures describe embodiments sharing various common elements and features with other embodiments, similar elements and features are given the same reference numerals and redundant description thereof may be omitted below.

In certain embodiments, the methods for protecting a down-payment value associated with a purchase of a depreciating asset may be offered, or otherwise classified under relevant local, state, and/or federal laws, as a vehicle value protection agreement (VVPA), an option contract, a motor club, an automobile club, an automobile association, an automobile service corporation, or the like.

The term “application” refers to an application executing on a desktop computer or server, or on a mobile device, such as a media player, laptop, smartphone, and/or tablet. The term “application” further refers to an application executing on a web browser on any computing unit, including an electronic device 110, a computing device 130, and/or a server 150, as further shown in, and described in connection with, FIGS. 1-7.

FIG. 1 illustrates an exemplary embodiment of a partial block diagram of an electronic device 110, in accordance with aspects of the present disclosure. The electronic device 110, which may be associated with a user, such as a user device 110, a dealership, such as a dealership device 110, or a payor or insurer, such as a payor device 110, may include one or more of a processor 112, a storage 114 or a storage medium 114, a communication unit 116, and/or display unit 118. The processor 112 may be a generic hardware processor, a special-purpose hardware processor, or a combination thereof. In embodiments having a generic hardware processor (e.g., as a central processing unit (CPU) available from manufacturers such as Intel and AMD), the generic hardware processor is configured to be converted to a special-purpose processor by means of being programmed to execute and/or by executing a particular algorithm in the manner discussed herein for providing a specific operation or result. It should be appreciated that the processor 112 may be any type of hardware and/or software processor and is not strictly limited to a microprocessor or any operation(s) only capable of execution by a microprocessor, in whole or in part. The electronic device 110 may include an input/output (I/O) adapter (not shown) that can communicate with an external device(s) (not shown) and/or a user interface adapter (not shown) configured to link to a user input device(s), such as a mouse, keyboard, touch-screen interface, and the like.

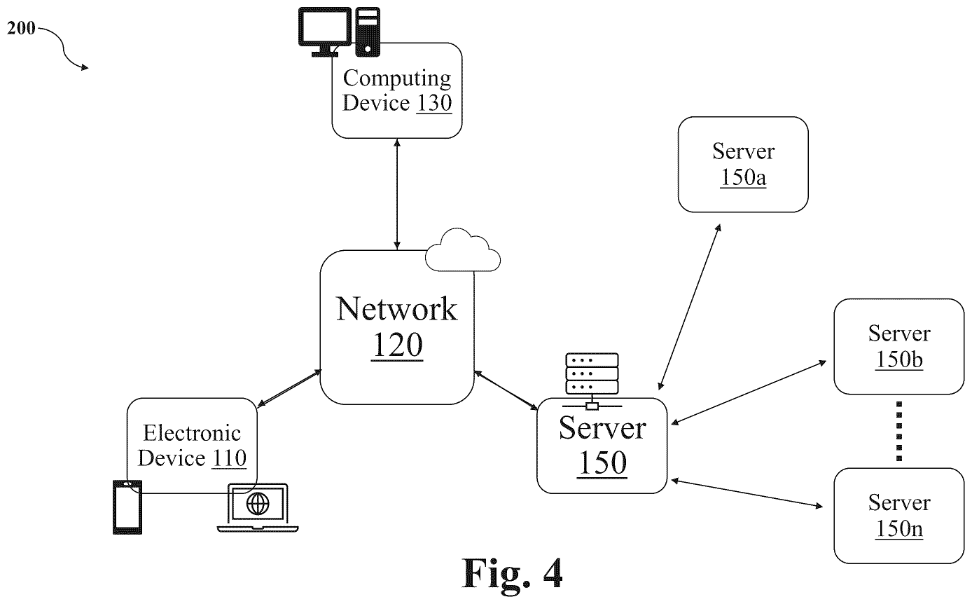

The communication unit 116 of the electronic device 110 may be configured to permit communication—for example via a network 120, as depicted in FIG. 4—which may be performed by wired interface, wireless interface, or a combination thereof. The electronic device 110 may store one or more sets of instructions in a volatile and/or non-volatile storage 114. The one or more sets of instructions may be configured to be executed by the processor 112 to perform at least one operation corresponding to the one or more sets of instructions. The electronic device 110 may include a display unit 118. The display unit 118 may be embodied within the electronic device 110 in one embodiment and/or may be configured to be either wired to or wirelessly interfaced with the electronic device 110. The display unit 118 may be configured to operate, at least in part, based upon one or more operations described herein, as executed by the processor 112 or as otherwise inputted by the external device (not shown) and/or user interface adapter (not shown).

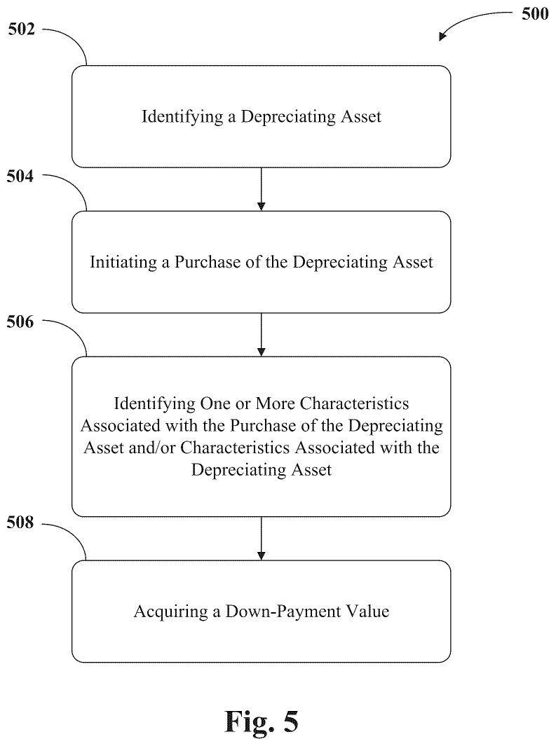

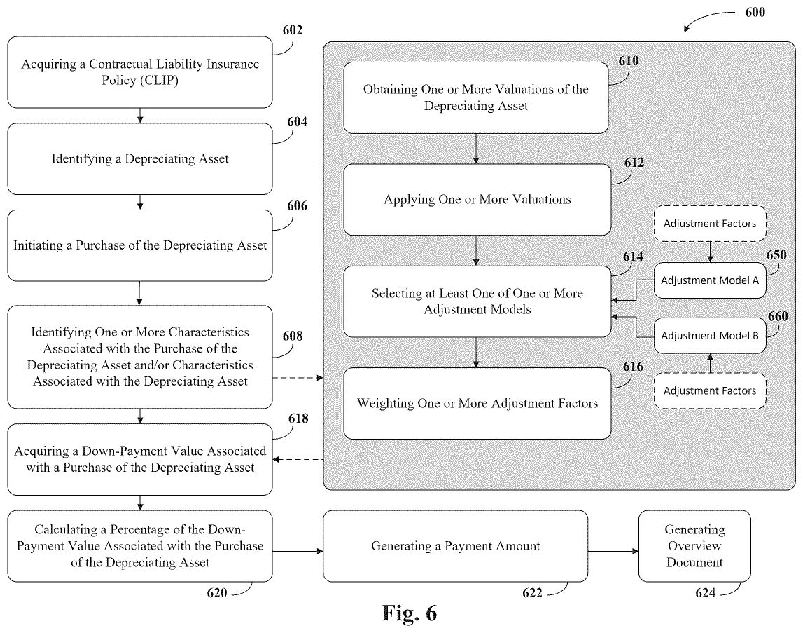

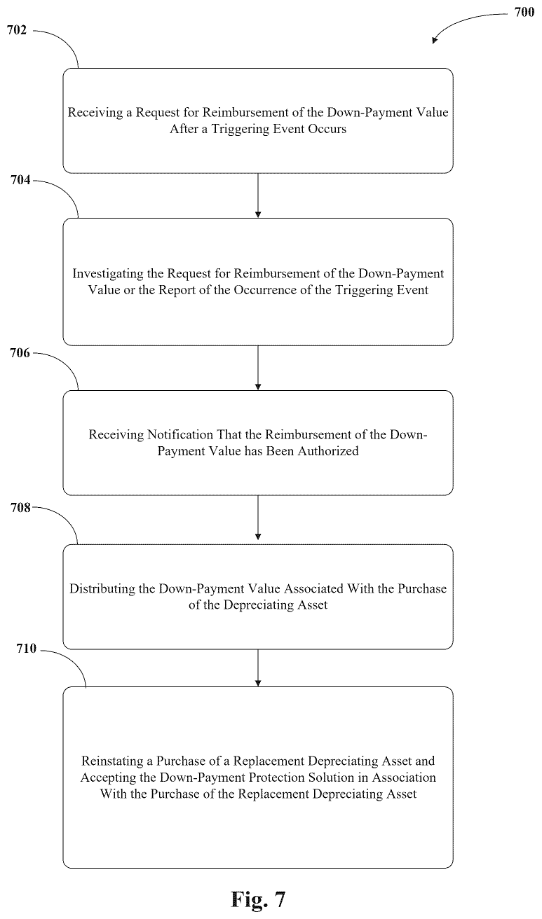

The electronic device 110 may be a standalone device or may be used in combination with at least one external component either locally or remotely communicatively couplable with the electronic device 110—for example via the network 120, as depicted in FIG. 4. The electronic device 110 may be configured to store, access, or provide at least a portion of information usable to permit one or more operations described herein, including an identification of a depreciating asset, depicted as an operation 502 in FIG. 5 or as an operation 604 in FIG. 6. The electronic device 110 may additionally or alternatively be configured to store content data and/or metadata to enable one or more operations described herein. In optional embodiments, the electronic device 110 may constitute one or more of a desktop computer, a portable computer, such as a laptop, a notebook, or a tablet-type computer, or smart cellular devices, including cellular devices employing an Android-based operating system (OS) or an Apple-based operating system (OS). For example, the electronic device 110 may be configured to present a user with a portal, webpage, interface, and/or downloadable application to enable one or more operations described herein.

FIG. 2 illustrates an exemplary embodiment of a computing device 130, in accordance with aspects of the present disclosure. The computing device 130 may include one or more of a processor 132, a storage 134 or a storage medium 134, a communication unit 136, a display unit 138. At least one computing device 130 may be used to perform one or more operations or functions described herein, either alone or in combination with one or more other computing device 130 and/or other computing element, including (without limitation): acquisition of a down-payment value associated with a purchase of the depreciating asset, depicted as an operation 508 of FIG. 5 or as an operation 618 in FIG. 6; a selection of at least one of one or more adjustment models, depicted as an operation 614 in FIG. 6; a calculation of a percentage of a down-payment value associated with the purchase of the depreciating asset, depicted as an operation 620 in FIG. 6; and a generation of a payment amount based upon at least the calculated percentage of the down-payment value associated with the purchase of the depreciating asset, depicted as an operation 622 in FIG. 6.

The processor 132 may be a generic hardware processor, a special-purpose hardware processor, or a combination thereof. In embodiments having a generic hardware processor (e.g., as a central processing unit (CPU) available from manufacturers such as Intel and AMD), the generic hardware processor is configured to be converted to a special-purpose processor by means of being programmed to execute and/or by executing a particular algorithm in the manner discussed herein for providing a specific operation or result. It should be appreciated that the processor 132 may be any type of hardware and/or software processor and is not strictly limited to a microprocessor or any operation(s) only capable of execution by a microprocessor, in whole or in part.

The communication unit 136 of the computing device 130 may be configured to permit communication (e.g., via the network 120, as depicted in FIG. 4), which may be performed by wired interface, wireless interface, or a combination thereof. The computing device 130 may store one or more sets of instructions in a volatile and/or non-volatile storage 134. The one or more sets of instructions may be configured to be executed by the processor 132 to perform at least one operation corresponding to the one or more sets of instructions. The computing device 130 may include a display unit 138. The display unit 138 may be embodied within the computing device 130 in one embodiment and/or may be configured to be either wired to or wirelessly interfaced with the computing device 130. The display unit 138 may be configured to operate, at least in part, based upon one or more operations of the described herein, as executed by the processor 132.

The computing device 130 may be a standalone device or may be used in combination with at least one external component either locally or remotely communicatively couplable with the computing device 130 (e.g., via the network 120, as depicted in FIG. 4). The computing device 130 may be configured to store, access, or provide at least a portion of information usable to permit one or more operations described herein. For example, the computing device 130 may be configured to provide a portal, webpage, interface, and/or downloadable application to the electronic device 110 to enable one or more operations described herein. The computing device 130 may additionally or alternatively be configured to store content data and/or metadata to enable one or more operations described herein. The one or more interfaces may be accessible to a user of the electronic device 110, for example via communications between the computing device 130 and the electronic device 110 via the network 120. In optional embodiments, the computing device 130 may constitute one or more of a desktop computer, a portable computer, such as a laptop, a notebook, or a tablet-type computer, or smart cellular devices, including cellular devices employing an Android-based operating system (OS) or an Apple-based operating system (OS). The computing device 130 may include an input/output (I/O) adapter (not shown) that can communicate with an external device(s) (not shown) and/or a user interface adapter (not shown) configured to link to a user input device(s), such as a mouse, keyboard, touch-screen interface, and the like.

FIG. 3 illustrates an exemplary embodiment of a partial block diagram of a server 150, in accordance with aspects of the present disclosure. One or more servers 150, including one or more servers 150a, 150b, . . . , 150n, as illustratively conveyed in FIG. 4, may include one or more devices configured to store data, to operate upon data, and/or to perform at least one action described herein. The server 150 may include one or more of a processor 152, a storage 154 or a storage medium 154, and/or a communication unit 156. For the purpose of this disclosure, when referring to the server 150, the server 150 may constitute any one or more of servers 150a, 150b, . . . , or 150n. Like the computing device 130, the one or more servers 150a, 150b, . . . , 150n may be configured to provide a portal, webpage, interface, and/or non-downloadable application, to the electronic device 110 for example, to enable one or more operations described herein. Further, like the computing device 130, the server 150 may be used to perform one or more operations or functions described herein, either alone or in combination with one or more other server 150n and/or other computing element, including (without limitation): acquisition of a down-payment value associated with a purchase of the depreciating asset, depicted as an operation 508 of FIG. 5 or as an operation 618 in FIG. 6; a selection of at least one of one or more adjustment models, depicted as an operation 614 in FIG. 6; a calculation of a percentage of a down-payment value associated with the purchase of the depreciating asset, depicted as an operation 620 in FIG. 6; and a generation of a payment amount based upon at least the calculated percentage of the down-payment value associated with the purchase of the depreciating asset, depicted as an operation 622 in FIG. 6

The processor 152 may be a generic hardware processor, a special-purpose hardware processor, or a combination thereof. In embodiments having a generic hardware processor (e.g., as a central processing unit (CPU) available from manufacturers such as Intel and AMD), the generic hardware processor may be configured to be converted to a special-purpose processor by means of being programmed to execute and/or by executing a particular algorithm in the manner discussed herein for providing a specific operation or result. It should be appreciated that the processor 152 may be any type of hardware and/or software processor and is not strictly limited to a microprocessor or any operation(s) only capable of execution by a microprocessor, in whole or in part.

The communication unit 156 may be configured to permit communication (e.g., via the network 120, as depicted in FIG. 4), which may be performed by wired interface, wireless interface, or a combination thereof. Each server 150 may store one or more sets of instructions in a volatile and/or non-volatile storage 154. The one or more sets of instructions may be configured to be executed by the processor 152 to perform at least one operation corresponding to the one or more sets of instructions.

A plurality of servers 150, such as servers 150a, 150b, . . . , 150n, may be configured in a distributed manner, such as a distributed computing system, cloud computing system, or the like. At least one server 150 may be configured to provide information, metadata, and/or combination thereof in relation to information associated with the depreciating asset or any information usable in a manner described herein to provide or to assist in providing a process for protecting the down-payment value associated with the purchase of the depreciating asset. In addition, or alternatively, one or more servers 150 may be structurally and/or functionally equivalent to the computing device 130. At least one server 150 may be a third-party server configured to provide information to the computing device 130 to permit or enhance at least one operation or function described herein as being performed by or in association with the computing device 130.

The one or more servers 150a, 150b, . . . , 150n may include a database server (not shown). The database server (not shown) may store various types of data and/or instructions for performing at least some of the steps presented herein. The database server (not shown) may include a processor (not shown), a storage or a storage medium (not shown), and/or a communication unit (not shown). The database server (not sown) may have other software components, such as a database engine (not shown), allowing for security mechanisms to protect data stored on the storage medium (including authentication, authorization, encryption, and auditing features), backup and recovery mechanisms (not shown), and more.

FIG. 4 illustrates an exemplary embodiment of a partial network diagram of a system 200, in accordance with aspects of the present disclosure. The system 200 includes a simplified partial network block diagram reflecting a functional communicative configuration implementable according to aspects of the present disclosure. The system 200 includes the electronic device 110 couplable to the network 120, the computing device 130 couplable to the network 120, and one or more servers 150a, 150b, . . . , 150n couplable to the network 120. In one exemplary embodiment, the network 120 includes the Internet, a public network, a private network, or any other communications medium capable of conveying electronic communications, either alone or in combination. Connection between one or more computing elements described herein and the network 120 may be configured to be performed by wired interface, wireless interface, or a combination thereof, without departing from the spirit and the scope of the present disclosure.

FIG. 5 illustrates a flowchart providing an exemplary embodiment of a method 500 of protecting a down-payment value associated with a purchase of a depreciating asset, in accordance with aspects of the present disclosure. In certain embodiments, the method 500 may be offered, or otherwise classified under relevant local, state, and/or federal laws, as a vehicle value protection agreement (VVPA), an option contract, a motor club, an automobile club, an automobile association, an automobile service corporation, or the like. The method 500 may form a portion of or otherwise be associated with a method 600 (as discussed with reference to FIG. 6) or a method 700 (as discussed with reference to FIG. 7), or alternatively the method 500 may be entirely independent thereof.

The method 500 may commence with an operation 502 of identifying a depreciating asset for purchase. In certain embodiments, the buyer of the depreciating asset may be an anticipated user and/or a user of the depreciating asset. For purpose of this disclosure, an “anticipated user” may constitute the “user” as previously defined, or may differ from the “user,” such as in circumstances where the “user” acts on behalf of, or with the supervision of, the “anticipated user.” In certain embodiments, the buyer may be an individual or business entity, and the seller may be a dealership or other party offering one or more depreciating assets for sale. The depreciating asset may be a motorized vehicle (e.g., automobiles, motorcycles, tractor-trailer trucks, or buses), a railed vehicle (e.g., trains, trams, or trolleys), a watercraft (e.g., ships or boats), an amphibious vehicle (e.g., screw-propelled vehicles or hovercraft), or an aircraft (e.g., airplanes, helicopters, or aerostat) to name a few examples.

The method 500 may continue with an operation 504 of initiating a purchase of the depreciating asset. Initiating the purchase of the depreciating asset may include determining, and agreeing upon, a sale price of the depreciating asset, applying for pre-approval of a loan associated with the purchase of the depreciating asset on behalf of the buyer, and/or determining a loan value to name a few examples. The sale price of the depreciating asset may be the manufacturer's suggested retail price (MSRP) adjusted in light of dealer discounts, rebates, special offers, vehicle title and registration fees, destination fees, documentation fees, sales tax, and/or other considerations. The loan value may be equal to the difference between the sale price of the depreciating asset and total of the trade-in value and down-payment value, as further described in connection with an operation 506.

The method 500 may continue with the operation 506 of identifying one or more characteristics associated with the purchase of the depreciating asset and/or characteristics associated with the depreciating asset. The one or more characteristics may include, for example, the sale price of the depreciating asset, the trade-in value of the buyer's existing depreciating asset, the down-payment value, the loan value, the loan interest rate, the term of the loan, characteristics associated with the buyer, including the buyer's credit score, characteristics associated with the seller, one or more attributes associated with the depreciating asset, such as a type of the depreciating asset, a make and a model of the depreciating asset, a service life of the depreciating asset, or a service history of the depreciating asset, and the like. Reception or acquisition of the one or more characteristics associated with the purchase of the depreciating asset and/or characteristics associated with the depreciating asset may be performed by the computing device 130 or the one or more servers 150, whether by user-initiated designation on the electronic device 110 via a user interface accessible in conjunction with the display unit 118, or by automated or other non-user-based initiation, such as through the computing device 130 or the one or more servers 150. For example, the one or more characteristics of the purchase of the depreciating asset and/or characteristics associated with the depreciating asset may be identified by user input on the electronic device 110 via the network 120 wherein the seller, buyer, and/or a third-party may provide the user input. The one or more characteristics of the purchase of the depreciating asset may be stored on the electronic device 110 on the storage 114, the computing device 130, for example at the storage 134, or may alternatively be stored on the server 150, for example at the storage 156.

The method 500 may continue with an operation 508 of receiving or acquiring a down-payment value associated with the purchase of the depreciating asset. Reception or acquisition of the down-payment value associated with the purchase of the depreciating asset may be performed by the computing device 130 or the one or more servers 150, whether by user-initiated designation on the electronic device 110 via a user interface accessible in conjunction with the display unit 118, or by automated or other non-user-based initiation, such as through the computing device 130 or the one or more servers 150. For example, a user-initiated designation on the electronic device 110 may stem or arise from the user (e.g., the buyer) authorizing or desiring to proceed with the purchase of the depreciating asset.

The operation 508 may include calculating the down-payment value associated with the purchase of the depreciating asset may be carried out by the computing device 130 and/or the one or more servers 150, based at least in part on at least one of the identified one or more characteristics associated with the purchase of the depreciating asset and/or characteristics associated with the depreciating asset. In optional embodiments, the down-payment value may be a percentage of the purchase price associated with the purchase of the depreciating asset, the percentage may range anywhere from 0.01% to 100.00% of the purchase price associated with the purchase of the depreciating asset.

FIG. 6 illustrates a flowchart providing an exemplary embodiment of a method 600 of protecting a down-payment value associated with a purchase of a depreciating asset, in accordance with aspects of the present disclosure. In certain embodiments, the method 600 may be offered, or otherwise classified under relevant local, state, and/or federal laws, as a vehicle value protection agreement (VVPA), an option contract, a motor club, an automobile club, an automobile association, an automobile service corporation, or the like. The method 600 may form a portion of or otherwise be associated with the method 500 or the method 700 (as discussed with reference to FIG. 7), or alternatively the method 600 may be entirely independent thereof.

In certain embodiments, the method 600 may commence with an operation 602 of acquiring, by a seller of one or more depreciating assets, such as a dealership to name one example, a contractual liability insurance policy (CLIP) from a third-party, such as an insurer to name one example. The CLIP may be configured to cover certain contractual liabilities of the seller. In certain embodiments, the CLIP may be characterized as a reimbursement, or “first dollar,” CLIP wherein the third-party may reimburse the policy holder, in this case the seller, for every claim in which the policy holder pays. In other embodiments, the CLIP may be characterized as a default, or failure-to-perform, CLIP wherein the third-party compensates a claimant only if the policy holder, in this case the seller, fails to fulfill their obligation to the claimant. The “claimant” as used herein may refer to any person or entity who uses the down-payment value protection solution embodied in methods 500, 600, and/or 700 to protect or seek reimbursement of a down-payment value (e.g., the buyer). The seller may acquire the CLIP, for example, by the electronic device 110 via the Internet, a public network, or a private network of the network 120, or by other means.

The method 600 may continue with an operation 604 of identifying the depreciating asset, for example by the electronic device 110 via the network 120. Operation 604 of identifying the depreciating asset may be performed simultaneously with, or may be otherwise associated with, operation 606 of initiating a purchase of the depreciating asset and/or operation 608 of identifying one or more characteristics associated with the purchase of the depreciating asset. The identification of the depreciating asset may include one or more attributes associated with the depreciating asset, such as a type of the depreciating asset, a make and a model of the depreciating asset, a service life of the depreciating asset, or a service history of the depreciating asset. In addition, or alternatively, the identification of the depreciating asset may include one or more additional attributes with the depreciating asset and/or metadata related to the depreciating asset. The identification of the depreciating asset may be stored on the electronic device 110 on the storage 114. In optional embodiments, the depreciating asset may be identified by the computing device 130 and/or the by the one or more servers 150 via the network 120 (e.g., via a portal provided by the computing device 130 in an exemplary embodiment). At least a portion of the identification of the depreciating asset may be stored on the computing device 130, for example at the storage 134, or may alternatively be stored on the server 150, for example at the storage 156.

The method 600 may continue with an operation 606 of initiating a purchase of a depreciating asset. In certain embodiments, the buyer of the depreciating asset may be an anticipated user and/or a user of the depreciating asset. In certain embodiments, the buyer may be an individual or business entity, and the seller may be a dealership or other party offering one or more depreciating assets for sale. The depreciating asset may be a motorized vehicle (e.g., automobiles, motorcycles, tractor-trailer trucks, or buses), a railed vehicle (e.g., trains, trams, or trolleys), a watercraft (e.g., ships or boats), an amphibious vehicle (e.g., screw-propelled vehicles or hovercraft), or an aircraft (e.g., airplanes, helicopters, or aerostat) to name a few examples. Initiating the purchase of the depreciating asset may include determining, and agreeing upon, a sale price of the depreciating asset, applying for pre-approval of a loan associated with the purchase of the depreciating asset on behalf of the buyer, and/or determining a loan value to name a few examples. The sale price of the depreciating asset may be the manufacturer's suggested retail price (MSRP) adjusted in light of dealer discounts, rebates, special offers, vehicle title and registration fees, destination fees, documentation fees, sales tax, and/or other considerations. The loan value may be equal to the difference between the sale price of the depreciating asset and total of the trade-in value and down-payment value.

In association with initiating the purchase of the depreciating asset, the seller may offer a down-payment protection solution to the buyer, and the buyer may accept the seller's offer or otherwise associate themselves with the down-payment protection solution. The seller and/or buyer may indicate that the buyer intends to purchase, take part in, and/or otherwise associate with the down-payment protection solution by, for example, the electronic device 110 via the network 120. The electronic device 110 may be associated with a user (e.g., the buyer), such as a user device 110, the dealership, such as a dealership device 110, or a payor or insurer (e.g., a third party providing the CLIP to the seller), such as a payor device 110.

The method 600 may continue with an operation 608 of identifying one or more characteristics associated with the purchase of the depreciating asset. The one or more characteristics may include, for example, the sale price of the depreciating asset, a trade-in value of the buyer's existing depreciating asset, the down-payment value, the loan value, the loan interest rate, the term of the loan, characteristics associated with the buyer, including the buyer's credit score, characteristics associated with the seller, including information related to the seller's CLIP, and the like. Reception or acquisition of the one or more characteristics associated with the purchase of the depreciating asset may be performed by the computing device 130 or the one or more servers 150, whether by user-initiated designation on the electronic device 110 via a user interface accessible in conjunction with the display unit 118, or by automated or other non-user-based initiation, such as through the computing device 130 or the one or more servers 150. For example, the one or more characteristics of the purchase of the depreciating asset may be identified by user input on the electronic device 110 via the network 120 wherein the seller, buyer, and/or a third-party may provide the user input. The one or more characteristics of the purchase of the depreciating asset may be stored on the electronic device 110 on the storage 114, the computing device 130, for example at the storage 134, or may alternatively be stored on the server 150, for example at the storage 156.

In certain optional embodiments, the method 600 may continue with the operation 618 of receiving or acquiring a down-payment value associated with the purchase of the depreciating asset. Reception or acquisition of the down-payment value associated with the purchase of the depreciating asset may be performed by the computing device 130 or the one or more servers 150, whether by user-initiated designation on the electronic device 110 via a user interface accessible in conjunction with the display unit 118, or by automated or other non-user-based initiation, such as through the computing device 130 or the one or more servers 150. For example, a user-initiated designation on the electronic device 110 may stem or arise from the user (e.g., the buyer) authorizing or desiring to proceed with the purchase of the depreciating asset.

In other optional embodiments, as a precursor to the operation 618 of acquiring a down-payment value, the method 600 may include operations 610-616. Operation 610 may include obtaining one or more valuations of the depreciating asset by the computing device 130, or alternatively by the one or more servers 150. In optional embodiments, the one or more valuations may include one or more of a comparable valuation, a value-extrapolation valuation, or other industry-standard valuation approaches. The comparable valuation may encompass or entail a projection of a value of the depreciating asset by review, comparison, and contrast of the depreciating asset with respect to another of the deprecating asset. The value-extrapolation valuation may encompass or entail an estimation of a value of the depreciating asset by review, comparison, contrast, predictive analytics, and other relevant factors of another of the depreciating asset. In other optional embodiments, the one or more valuations for the depreciating asset may constitute any one or more of the following industry-standard valuation approaches: a Blue Book, such as the Kelley Blue Book, a Yellow Book, such as the National Automobile Dealers Association (NADA) Yellow Book from J.D. Power & Associates, a Black Book, such as the Black Book from Hearst publishing umbrella, or any other industry-standard valuation approaches pertaining to, or applicable to, a type of the depreciating asset, which may include one or more of a motorized vehicle (e.g., automobiles, motorcycles, tractor-trailer trucks, or buses), a railed vehicle (e.g., trains, trams, or trolleys), a watercraft (e.g., ships or boats), an amphibious vehicle (e.g., screw-propelled vehicles or hovercraft), an aircraft (e.g., airplanes, helicopters, or aerostat), or a spacecraft.

Operation 612 may include applying a one of the one or more valuations to the depreciating asset by the computer device 130, or alternatively by the one or more severs 150. Application of one of the one or more valuations to the depreciating asset thereby assigns a value to the depreciating asset, which may be expressed as an amount in commercially- and/or internationally-accepted currency, including (without limitation) the United States Dollar, the Euro, the Yen, the Yuan, the British Pound, and/or any other commercially-and/or internationally-accepted currency.

Operation 614 may include selecting at least one of one or more adjustment models corresponding to the purchase of the depreciating asset. The one or more adjustment models may be selected, or selectively retrieved, by the computing device 130 or the one or more servers, or both, and the one or more adjustment models may be accessible from the storage medium 134 of the computing device 130 and/or the storage medium 154 of the one or more servers 150.

In optional embodiments, one of the one or more adjustment models may constitute an adjustment model A, designated as adjustment model 650 in FIG. 6. The adjustment model 650 may account for one or more adjustment factors. The adjustment factors may comprise any or more of the following: an age of an anticipated user of the depreciating asset, including whether the anticipated user meets a maximum and/or minimum age requirement to execute the purchase of the depreciating asset; a sex of the anticipated user of the depreciating asset, such as male or female; a primary location of the anticipated user of the depreciating asset, such as a primary residential address, primary business address, or other address commonly associated with the anticipated user; an accident history of the anticipated user, including (without limitation) a history of lability, collision, or other claims related to an operation of another of the depreciating asset; the type of the depreciating asset, such as one or more of the motorized vehicle (e.g., automobiles, motorcycles, tractor-trailer trucks, or buses), the railed vehicle (e.g., trains, trams, or trolleys), a watercraft (e.g., ships or boats), the amphibious vehicle (e.g., screw-propelled vehicles or hovercraft), the aircraft (e.g., airplanes, helicopters, or aerostat), or the spacecraft; a make and a model of the depreciating asset, including (without limitation) a business name or company brand, and/or a product name, associated with the depreciating asset; an age of the depreciating asset, including (without limitation) a year associated with a production, manufacture, and/or assembly of the depreciating asset; a service life of the depreciating asset, including (without limitation) a projected or determined remaining useful life of the depreciating asset; a service life of the depreciating asset, including (without limitation) an outlined, summarized, and/or detailed recitation of maintenance, upgrades, updates, modifications, and/or support services rendered with respect to, or in connection with, the depreciating asset; an actual or expected extent of usage of the depreciating asset, including (without limitation) an actual, projected, estimated, or predicted number of miles (or other distance or displacement) traversed, or amount of fuel or other energy consumed, by the depreciating asset; an expected frequency of usage of the depreciating asset, including (without limitation) a projected, estimated, or predicted rate at which the depreciating asset is used, as measured by, for example, a number of miles (or other distance or displacement) traversed, or amount of fuel or other energy consumed, by the depreciating asset; or a type of usage of the depreciating asset, including (without limitation) a personal usage, a recreational or professional-sport usage, or a business or commercial usage.

In optional embodiments, one of the one or more adjustment models may constitute an adjustment model B, designated as adjustment model 660 in FIG. 6. The adjustment model 660 may account for the adjustment factors as follows: a valuation of the depreciating asset, which may be obtained and applied to the depreciating asset vis-à-vis the operation 610 and the operation 612, as previously described herein; and the down-payment value associated with the purchase of the depreciating asset, which may be acquired or obtained vis-à-vis the operation 618, as previously described herein. Operation 616 may include weighting one or more of the adjustment factors set forth in the adjustment model 650 (i.e., adjustment model A) and the adjustment model 660 (i.e., the adjustment model B). The operation 616 of weighting the one or more of the adjustment factors may be quantitively analyzed and computed by the computing device 130 and/or the one or more servers 150. The weighting may be selectively applied to at least one of the one or more adjustment factors, or the weighting may be pre-determined and applied to the at least one of the one or more adjustment factors.

In certain optional embodiments, operation 618 of acquiring a down-payment value associated with a purchase of the depreciating asset may include operations 610-616 such that any one or more of the operations 610-616 may form a portion of, or otherwise be associated with, operation 610. In other optional embodiments, the operations 610-616 may be independent of operation 618.

The method 600 may continue with the operation 620 of calculating a percentage of the down-payment value associated with the purchase of the depreciating asset based at least in part on the at least one of the one or more adjustment models. The operation 620 of calculating the percentage of the down-payment value associated with the purchase of the depreciating asset may be carried out by the computing device 130 and/or the one or more servers 150, based at least in part on the at least one of the one or more adjustment models residing in the storage medium 134 of the computing device 130 and/or in the storage medium 154 of the one or more servers 150. In optional embodiments, the percentage of the down-payment value may range anywhere from 0.01% to 100.00% of the down-payment value associated with the purchase of the depreciating asset.

In alternative embodiments, the method 600 may continue with an operation 622 of generating a payment amount based upon at least the calculated percentage of the down-payment value associated with the purchase of the depreciating asset based at least in part on the at least one of the one or more adjustment models. Following calculation of the percentage of the down-payment value, the computing device 130 and/or the server 150 may generate the payment amount. The generated payment amount may be transmitted to the electronic device 110 vis-à-vis the communication unit 136 of the computing device 130 and/or the communication unit 156 of the one or more servers 150, and the payment amount may be accessible or reviewable on the electronic device 110 through the display unit 118. In optional embodiments, the operation 622 of generating the payment amount may further include generating a recurring payment obligation, including (without limitation) a daily, a weekly, a bi-weekly, a monthly, a bi-monthly, an annual, a bi-annual, and/or a semi-annual recurring payment obligation. In other optional embodiments, the recurring payment obligation may be premised on any one or more of a fixed rate schedule, a variable rate schedule, or a fixed-variable rate schedule.

In alternative embodiments, the method 600 may continue with an operation 624 of generating at least one overview document for the depreciating asset and the generated payment amount based upon at least the calculated down-payment value associated with the purchase of the depreciating asset. The at least one overview document may be generated by the computing device 130 and/or the one or more servers 150, and the at least one overview document may be transmitted to the electronic device 110 vis-à-vis the communication unit 136 of the computing device 130 and/or the communication unit 156 of the one or more servers 150. The at least one overview document may be presented to the user or the dealer on the display unit 118 of the electronic device 110. The at least one overview document may comprise any and all information pertaining to the depreciating asset, including the payment amount, such as the amount of the down-payment value, the valuation of the depreciating asset, the recurring payment obligation (if applicable), and other pertinent characteristics.

FIG. 7 illustrates a flowchart providing an exemplary embodiment of a method 700 of distributing a down-payment value associated with a purchase of a depreciating asset after a triggering event has occurred, in accordance with aspects of the present disclosure. In certain embodiments, the method 700 may be offered, or otherwise classified under relevant local, state, and/or federal laws, as a vehicle value protection agreement (VVPA), an option contract, a motor club, an automobile club, an automobile association, an automobile service corporation, or the like. The method 700 may form a portion of or otherwise be associated with the method 500 and/or the method 600, or alternatively may be entirely independent thereof.

The method 700 may commence with an operation 702 of receiving a request for reimbursement of the down-payment value after a triggering event has occurred or otherwise reporting the occurrence of a triggering event. The triggering event may be defined in documentation associated with the down-payment protection solution agreed to by the buyer and seller. For example, the triggering event may be a loss of the depreciating asset may be where an insurance adjuster, or other pertinent third-party individual or entity, declares that the automobile is “totaled”—i.e., a value of estimated repairs for the automobile exceeds a fair-market value (FMV) of the automobile. In another example, the triggering event may be a loss of the depreciating asset due to the theft thereof. In certain embodiments, the claimant may be the buyer, who may, through user input on an electronic device 110, computing device 130, or other device on the network 120, request reimbursement from the seller (e.g., a dealership where the buyer purchased the depreciating asset) or a third-party (e.g., an insurer who sold a CLIP to the seller). The request may be received by the computing device 130 or the one or more servers 150 to name a few examples.

The method 700 may continue with an operation 704 of investigating the request for reimbursement of the down-payment value or the report of the occurrence of the triggering event. The operation 704 may include determining a FMV of the depreciating asset, verifying the depreciating asset is “totaled,” verifying the triggering event has taken place, verifying the triggering event was not otherwise associated with fraudulent behavior, or the like. The operation 704 may be carried out the seller, an insurer, and/or a third party. Once the investigation of the request for reimbursement of the down-payment value is complete, the party investigating may, via user input on the electronic device 110 for example, authorize or deny the reimbursement of the down-payment value.

The method 700 may continue with an operation 706 of receiving notification that the reimbursement of the down-payment value has been authorized. The notification may be received by the buyer, seller, and/or insurer, depending on, for example, who investigated the request for reimbursement of the down-payment value or the report of the occurrence of the triggering event. The notification may be received on the electronic device 110 via the network 120.

The method 700 may continue with an operation 708 of distributing the down-payment value associated with the purchase of the depreciating asset. In certain embodiments, for example where the seller has acquired a reimbursement CLIP, the seller may distribute the down-payment value to the claimant. The seller may then request reimbursement from the third-party from whom they acquired the reimbursement CLIP, such as an insurer. In other embodiments, for example where the seller has acquired a default CLIP, the seller may simply distribute the down-payment value to the claimant. If the seller fails to distribute the down-payment value to the claimant, the claimant may then request reimbursement from the third-party form whom the seller acquired the default CLIP, such as an insurer.

As part of distributing the down-payment value associated with the purchase of the depreciating, the down-payment value associated with the purchase of the depreciating asset, or other characteristics associated therewith, may be received or acquired by the computing device 130 or the one or more servers 150, whether by user-initiated designation on the electronic device 110 via a user interface accessible in conjunction with the display unit 118, or by automated or other non-user-based initiation, such as through the computing device 130 or the one or more servers 150. The down-payment value and other characteristics associated with the purchase of the depreciating asset may be stored on the computing device 130, for example at the storage 134, or may alternatively be stored on the server 150, for example at the storage 156.

The buyer may be reimbursed in an amount equal to the down-payment value. In certain embodiments, the reimbursement may be in the form of a credit towards the purchase of a replacement depreciating asset, such as a dealer credit to name one example. In other embodiments, the reimbursement may be in the form of an earmarked payment that may only be used towards the purchase of a replacement depreciating asset, such as a cashier's check made payable to a specific seller of depreciating assets. In certain embodiments, such as an embodiment wherein the seller acquires a reimbursement CLIP, the buyer may be reimbursed directly from a third-party associated with the CLIP, such as an insurer to name an example. In other embodiments, such as an embodiment wherein the seller acquires a default CLIP, the buyer may be reimbursed from the seller and/or directly from a third-party associated with the CLIP (e.g., if the seller fails to fulfill their obligation under the CLIP).

In certain optional embodiments, the reimbursement may be adjusted for various factors. For example, when the buyer has positive equity in the depreciating asset subject to the triggering event—i.e., the distribution from an insurance policy covering the depreciating asset exceeds the outstanding amount owed by the buyer—the amount of positive equity may be deducted from the reimbursement.

The method 700 may continue with an operation 710 of reinitiating a purchase of a replacement depreciating asset and accepting the down-payment protection solution in association with the purchase of the replacement depreciating asset. The seller and/or buyer may indicate that the buyer intends to purchase, take part in, and/or otherwise associate with the down-payment protection solution by, for example, the electronic device 110 via the network 120. The electronic device 110 may be associated with a user (e.g., the buyer), such as a user device 110, the dealership, such as a dealership device 110, or a payor or insurer (e.g., a third party providing the CLIP to the seller), such as a payor device 110.

In certain optional embodiments, the down-payment protection solution as embodied in methods 500, 600, and 700 may not be classified under relevant local, state, and/or federal laws as insurance, and further may not be considered a form of insurance, an insurance program, or the like.

In other optional embodiments, the down-payment protection solution as embodied in methods 500, 600, and 700 may be offered, or otherwise be classified under relevant local, state, and/or federal laws, as a vehicle value protection agreement (VVPA). The Guaranteed Asset Protection Alliance (GAPA), in its model act, defines a VVPA as “a contractual agreement that provides a benefit towards either the reduction of some or all of the Contract Holder's current Finance Agreement deficiency balance, or towards the purchase or lease of a replacement Motor Vehicle or Motor Vehicle services, upon the occurrence of an adverse event to the Motor Vehicle including but not limited to loss, theft, damage, obsolescence, diminished value or depreciation.” The buyer may constitute the Contract Holder and the depreciating asset may constitute the Motor Vehicle.

In other embodiments, the down-payment protection solution as embodied in methods 500, 600, and 700 may be offered, or otherwise be classified under relevant local, state, and/or federal laws, as an option contract. For example, the buyer and a seller, a dealership for example, may enter into a contractual agreement as part of the down-payment protection solution wherein the buyer has the option to purchase a replacement depreciating asset from the seller at a price reduced by the down-payment value. However, as a condition of the contract, the option may only be exercised upon a loss of the buyer's depreciating asset.

In other optional embodiments, the down-payment protection solution as embodied in methods 500, 600, and 700 may be offered, or otherwise classified under relevant local, state, and/or federal laws, as a motor club, automobile club, automobile association, automobile service corporation, or the like.

To facilitate the understanding of the embodiments described herein, a number of terms have been defined above. The terms defined herein have meanings as commonly understood by a person of ordinary skill in the areas relevant to the present invention. The terminology herein is used to describe specific embodiments of the invention, but their usage does not delimit the invention, except as set forth in the claims.

The term “user” as used herein unless otherwise stated may refer to a driver, operator, or any other person or entity as may be, e.g., associated with the electronic device 110 or the computing device 130 for providing features and steps as disclosed herein.

It is understood that various operations, steps, or algorithms, including the method 500, the method 600, and the method 700 as described in connection with the electronic device 110, the computing device 130, and the one or more servers 150, or alternative devices, can be embodied directly in hardware, in a computer program product such as a software module executed by the processor 112, the processor 132, and/or the processor 152, or in a combination of the foregoing. The computer program product can reside in RAM memory, flash memory, ROM memory, EPROM memory, EEPROM memory, registers, hard disk, a removable disk, or any other form of computer-readable medium known in the art.

Terms such as “a,” “an,” and “the” are not intended to refer to only a singular entity, but rather include the general class of which a specific example may be used for illustration.

The phrases “in one embodiment,” “in optional embodiment(s),” and “in an exemplary embodiment,” or variations thereof, as used herein does not necessarily refer to the same embodiment, although it may.

As used herein, the phrases “one or more,” “at least one,” and “one or more of,” or variations thereof, when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item B and item C.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. The conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Thus, such conditional language is not generally intended to imply that features, elements, and/or states are in any way required for one or more embodiments, whether these features, elements, and/or states are included or are to be performed in any particular embodiment.

The previous detailed description has been provided for the purposes of illustration and description. Thus, although there have been described particular embodiments of new and useful APPARATUSES, SYSTEMS, AND METHODS OF PROTECTING A DOWN-PAYMENT VALUE ASSOCIATED WITH A PURCHASE OF A DEPRECIATING ASSET, it is not intended that such references be construed as limitations upon the scope of this disclosure except as set forth in the following claims. Thus, it is seen that the apparatus of the present disclosure readily achieves the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims.

What is claimed is:

1. A method for protecting a down-payment value associated with a purchase of a depreciating asset, comprising:
identifying the depreciating asset;
initiating the purchase of the depreciating asset;
identifying one or more characteristics associated with the purchase of the depreciating asset; and
acquiring the down-payment value associated with the purchase of the depreciating asset.

2. The method of claim 1, further comprising:
obtaining one or more valuations associated with the depreciating asset and applying one of the one or more valuations to the depreciating asset.

3. The method of claim 2, wherein:
the one or more valuations comprises one or more of a comparable valuation, a value-extrapolation valuation, or other industry-standard valuation approaches.

4. The method of claim 1, further comprising:
selecting at least one of one or more adjustment models corresponding to the purchase of the depreciating asset, the at least one of the one or more adjustment models accounts for one or more adjustment factors as follows:
an age of an anticipated user of the depreciating asset;
a sex of the anticipated user of the depreciating asset;
a primary location of the anticipated user of the depreciating asset;
an accident history of the anticipated user;
a type of the depreciating asset;
a make and a model of the depreciating asset;
an age of the depreciating asset;
a service life of the depreciating asset;
a service history of the depreciating asset;
an actual or expected extent of usage of the depreciating asset;
an expected frequency of usage of the depreciating asset; or
a type of usage of the depreciating asset.

5. The method of claim 4, further comprising:
weighting one or more of the adjustment factors.

6. The method of claim 4, wherein:
the type of the depreciating asset includes one or more of a motorized vehicle, a railed vehicle, a watercraft, an amphibious vehicle, an aircraft, or a spacecraft.

7. The method of claim 4, wherein:
the at least one of the one or more adjustment models accounts for adjustment factors as follows:
a valuation of the depreciating asset; and
the down-payment value associated with the purchase of the depreciating asset.

8. The method of claim 1, further comprising:
calculating a percentage of the down-payment value associated with the purchase of the depreciating asset based at least in part on the identified one or more characteristics associated with the purchase of the depreciating asset; and
generating a payment amount based upon at least the calculated percentage of the down-payment value associated with the purchase of the depreciating asset.

9. The method of claim 1, further comprising:
acquiring a contractual liability insurance policy (CLIP) from an insurer.

10. The method of claim 1, further comprising:
receiving a request for reimbursement of the down-payment value after a triggering event occurs.

11. The method of claim 10, further comprising:
investigating the request for reimbursement of the down-payment value.

12. The method of claim 11, further comprising:
receiving notification that the request for reimbursement of the down-payment value is authorized.

13. A system for protecting a down-payment value associated with a purchase of a depreciating asset, comprising:
a network;
an electronic device having a communication section communicatively couplable to the network and configured to transmit an identification of the depreciating asset;
a computing device having a communication section communicatively couplable to the network and configured to:
receive the down-payment value associated with a purchase of the depreciating asset;
select from a storage medium at least one of one or more adjustment models corresponding to the purchase of the depreciating asset; and
calculate a percentage of the down-payment value associated with the purchase of the depreciating asset based at least in part on the at least one of the one or more adjustment models.

14. The system of claim 13, wherein:
the computing device is further configured to:
obtain one or more valuations associated with the depreciating asset; and
apply one of the one or more valuations to the depreciating asset.

15. The system of claim 14, wherein:
the one or more valuations comprises one or more of a comparable valuation, a value-extrapolation valuation, or other industry-standard valuation approaches.

16. The system of claim 13, wherein:
the at least one of the one or more adjustment models accounts for one or more adjustment factors as follows:
an age of an anticipated user of the depreciating asset;
a sex of the anticipated user of the depreciating asset;
a primary location of the anticipated user of the depreciating asset;
an accident history of the anticipated user;
a type of the depreciating asset;
a make and a model of the depreciating asset;
an age of the depreciating asset;
a service life of the depreciating asset;
a service history of the depreciating asset;
an actual or expected extent of usage of the depreciating asset;
an expected frequency of usage of the depreciating asset; or
a type of usage of the depreciating asset.

17. The system of claim 13, wherein:
the at least one of the one or more adjustment models accounts for adjustment factors as follows:
one or more valuations of the depreciating asset; and
the down-payment value associated with the purchase of the depreciating asset.

18. The system of claim 13, wherein:
the computing device is further configured to:
generate a payment amount based upon at least the calculated percentage of the down-payment value associated with the purchase of the depreciating asset based at least in part on the at least one of the one or more adjustment models.

19. A method for distributing a down-payment value associated with a purchase of a depreciating asset, comprising:
receiving a request for reimbursement of the down-payment value after a triggering event occurs;
investigating the request for reimbursement of the down-payment value;
receiving notification that the request for reimbursement of the down-payment value is authorized; and
distributing the down-payment value.
